(19) United States
(12) Patent Application Publication
(10) Pub. No.: US 2014/0354095 A1
(43) Pub. Date: Dec. 4, 2014

(54) Rotating Electrical Machine

(71) Applicant: Hitachi Automotive Systems, Ltd., Hitachinaka-shi, Ibaraki (JP)

(72) Inventors: Toshio Ishikawa, Hitachinaka (JP); Masahiko Honma, Hitachinaka (JP); Kunihiro Ohsawa, Hitachinaka (JP); Yasuhiko Kimura, Hitachinaka (JP)

(21) Appl. No.: 14/361,191

(22) PCT Filed: Oct. 31, 2012
(86) PCT No.: PCT/JP2012/078089

§ 371 Date: May 28, 2014

(30) Foreign Application Priority Data
Nov. 29, 2011 (DE) 2011-260950

(51) Int. Cl. H02K 3/28

(52) U.S. Cl. CPC H02K 3/28
USPC 310/71

(57) ABSTRACT

Provided is a high-output, high-efficiency, and high-quality rotating electrical machine that is excellent in productivity, can prevent interference in coil end portions of stator coils, and has a stator with improved coolability. A stator coil 7 includes coils 74, 75 each of which is wound by a plurality of times across a plurality of slots and a connector 73 which connects the wound coils to each other so as to be continuously formed. A plurality of sets of stator coils 7 are arranged over the entire circumference of a stator core 6. Coil turn portions 74ct which are folded on vertexes of coil ends arranged in the axial direction of the stator core are each formed in a U shape, and radially arranged so that side faces thereof face the center. A gap penetrating from an inner peripheral side to an outer peripheral side is provided between adjacent ones of the coil turn portions 74ct on the vertexes of the coil ends.

### TECHNICAL FIELD

The present invention relates to a rotating electrical machine such as a power generator and a motor, and particularly to a rotating electrical machine having a structure suitable for cooling a stator coil.

### BACKGROUND ART

In recent years, environment regulations and energy saving direction on the end-user side have progressed. Therefore, in rotating electric machines for vehicle, it is required to provide one having high output and high efficiency at a low cost, and particularly, a highly effective improvement plan by a stator has been proposed.

A general stator used in a power generator, a motor, or the like includes a stator core which has a plurality of slots open in the peripheral direction on the inner peripheral surface thereof and a plurality of stator coils which are inserted into the slots and wound around teeth between the slots. Therefore, an operation for inserting the stator coils into the narrow slots for winding becomes complicated. As a result, there are problems such as a poor operation efficiency and that the space factor of the stator coils cannot be improved due to the interference between the coils on coil ends.

In view of such problems, first, there has been proposed a rotating electrical machine in which, in order to improve the space factor of stator coils, a rectangular wire having a generally quadrangular cross section is formed into a U shape and inserted into the slot from the axial direction of the stator core, and an end thereof is twisted in the peripheral direction at a predetermined angle and welded with a predetermined coil to thereby form a stator (see PTL 1, for example).

Second, the space factor of a stator coil is improved by continuously winding a rectangular wire having a generally quadrangular cross section in an overlapping manner (see PTL 1, for example).

### CITATION LIST

### Patent Literatures

PTL 1: JP 2006-211810 A
PTL 2: JP 2008-167567 A

### SUMMARY OF INVENTION

### Technical Problem

However, in the rotating electrical machine described in PLT 1, it is necessary to weld ends of a large number of segment coils. Therefore, problems in the productivity and the quality such as the insulation property of the welded part are of concern. This becomes a large problem particularly in a rotating electrical machine of high voltage.

Further, in the rotating electrical machine described in PLT 2, the shape of coil ends in the continuous coils is important, and there is a problem in the manufacturing thereof such that when coils of different phases make contact with each other in the coil ends, the coils cannot be inserted into the stator core.

Further, in recent years, the heat generation amount of a stator coil has increased due to high output of a rotating electrical machine. Therefore, it is also necessary to improve the coolability for the coil. For example, when the rotating electrical machine is a power generator (alternator), conventionally, the output thereof has been approximately 120 A at 14 V. On the other hand, the output has increased up to approximately 220 A at 14V, namely, has been becoming large current generation. As a result, the heat generation amount of a stator coil has been increasing.

It is an object of the present invention to provide a high-output, high-efficiency, and high-quality rotating electrical machine that is excellent in productivity, can prevent interference in coil end portions of stator coils, and has a stator with improved coolability.

### Solution to Problem

(1) In order to achieve the above-described object, according to the present invention, there is provided a rotating electrical machine including a stator and a rotor rotatably supported on an inner peripheral side of the stator with a gap therebetween, the stator includes: an annular stator core having a plurality of slots open toward an inner peripheral surface; and a plurality of sets of stator coils attached to the stator core through the slots and arranged over the entire circumference of the stator core, wherein each of the stator coils includes a plurality of coils wound by a plurality of times across the slots and a connector which connects the wound coils to each other so as to be continuously formed, coil turn portions which are folded on vertexes of coil ends arranged in the axial direction of the stator core are each formed in a U shape, the coil turn portions on the vertexes of the coil ends are radially arranged so that side faces thereof face the center, and a gap penetrating from an inner peripheral side to an outer peripheral side is provided between adjacent ones of the coil turn portions on the vertexes of the coil ends.

With such a configuration, it is possible to achieve a high-output, high-efficiency, and high-quality rotating electrical machine that is excellent in productivity, can prevent interference in coil end portions of stator coils, and has a stator with improved coolability.

(2) According to (1) above, it is preferable that turns of the coils wound by a plurality of times of each of the stator coils are aligned by a number of turns in the radial direction in a slot portion and aligned by a number of turns so as to be laminated in the axial direction in the coil turn portions on the vertexes of the coil ends.

(3) According to (2) above, it is preferable that each of the coil turn portions of the coil ends is arranged at an intermediate portion between positions of a toroidal coil, the positions being inserted into slots of the stator core.

(4) According to (2) above, it is preferable that an arrangement angle of each of the coil turn portions on the vertexes of the coil ends is equal to an angle of an exhaust window of a rear frame.

(5) According to (4) above, it is preferable that an exit angle of a blade of a cooling fan is equal to the arrangement angle of each of the coil turn portions on the vertexes of the coil ends.

(6) According to 2) above, it is preferable that the coil turn portions on the vertexes of the coil ends are arranged so that cooling wind generated by a blade of a cooling fan is applied to side faces of the coil turn portions on the vertexes of the coil ends.

(7) According to (1) above, it is preferable that each of the coils is a rectangular wire having a generally rectangular cross section, each of the coils wound by a plurality of times of the stator coils has a hexagonal shape, each of the slots of the stator core is divided into two in the radial direction, and one of coil portions to be inserted into a slot portion of each of the coils wound by a plurality of times of the stator coils is inserted into an outer peripheral side of a slot and the other coil portion is arranged in an inner peripheral side of a slot, an arrangement pitch of the coils wound by a plurality of times of the stator coils is equal to a pole pitch in each phase, a coil pitch of the coils wound by a plurality of times of the stator coils is shorter than the pole pitch, and the coil pitch of the coils wound by a plurality of times of the stator coils is 4/6 to 5/6.

### Advantageous Effects of Invention

According to the present invention, a high-output, high-efficiency, and high-quality rotating electrical machine that is excellent in productivity, can prevent interference in coil end portions of stator coils, and has a stator with improved coolability is obtained.

### BRIEF DESCRIPTION OF DRAWINGS

FIG. 1 is a cross-sectional view illustrating the entire configuration of a rotating electrical machine according to a first embodiment of the present invention.

FIG. 2 is a perspective view of a stator according to the first embodiment of the present invention when viewed from the rear side.

FIG. 3 is a circuit diagram according to the first embodiment of the present invention.

FIG. 4 is a perspective view of a stator coil as a U1-phase A coil according to the first embodiment of the present invention.

FIG. 5 is a perspective view of a toroidal coil according to the first embodiment of the present invention.

FIG. 6 is a diagram of the toroidal coil of FIG. 5 when viewed from P.

FIG. 7 is a diagram of the toroidal coil of FIG. 5 when viewed from F.

FIG. 8 is a coil arrangement diagram in the stator core according to the first embodiment of the present invention.

FIG. 9 is a perspective view of the stator according to the first embodiment of the present invention when viewed from the front side.

FIG. 10 is a detailed view of a slot portion of the stator core according to the first embodiment of the present invention.

FIG. 11 is a cross-sectional view of the rotating electrical machine according to the first embodiment of the present invention.

FIG. 12 is a diagram of the cross section taken near a front fan in a second embodiment of the present invention.

FIG. 13 is a diagram of the cross section taken near a rear fan in the second embodiment of the present invention.

FIG. 14 is a diagram of the cross section partially taken near a front fan in a third embodiment of the present invention.

FIG. 15 is a diagram of the cross section partially taken near a rear fan in the third embodiment of the present invention.

FIG. 16 is a diagram of the cross section partially taken near a front fan in a fourth embodiment of the present invention.

FIG. 17 is a diagram of the cross section partially taken near a rear fan in the fourth embodiment of the present invention.

### DESCRIPTION OF EMBODIMENTS

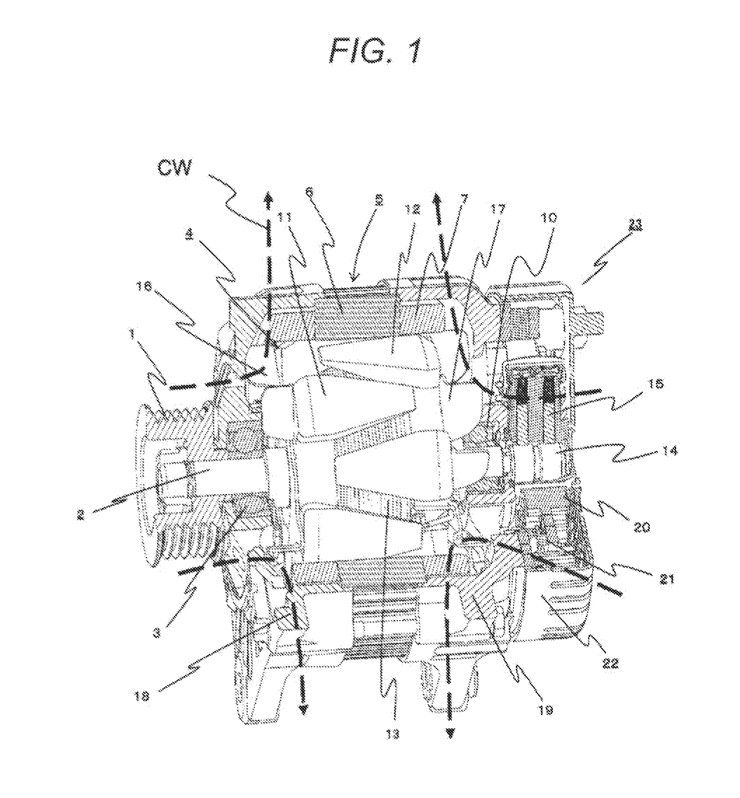

Hereinbelow, the configuration of a rotating electrical machine according to a first embodiment of the present invention will be described with reference to FIGS. 1 to 11.

First, the entire configuration of the rotating electrical machine according to the present embodiment will be described with reference to FIG. 1. Here, a vehicle AC power generator will be described as an example of the rotating electrical machine.

FIG. 1 is a cross-sectional view illustrating the entire configuration of the rotating electrical machine according to the first embodiment of the present invention.

A vehicle AC power generator 23 as the rotating electrical machine includes a rotor 4 and a stator 5. The rotor 4 includes a shaft 2, a field coil 13 arranged on the central part of the shaft 2, and a rotor core which includes a front side claw-like magnetic pole 11 and a rear side claw-like magnetic pole 12 each of which is formed of a magnetic material. The front side claw-like magnetic pole 11 and the rear side claw-like magnetic pole 12 are arranged to pinch the field coil 13 from both sides thereof to cover the field coil 13. Further, the front side claw-like magnetic pole 11 and the rear side claw-like magnetic pole 12 are arranged so that claws of the respective magnetic poles 11, 12 face each other and one of the claw-like magnetic poles meshes with the other claw-like magnetic pole.

The rotor 4 is arranged to face the inner periphery of the stator 5 with a slight gap therebetween. The shaft 2 of the rotor 4 is inserted into inner rings of a front bearing 3 and a rear bearing 10 so that the rotor 4 is freely rotatably supported thereon.

The stator 5 includes a stator core 6 and stator coils 7. The stator core 6 includes a plurality of laminated annular steel sheets and teeth each of which projects on the inner periphery thereof. Slots are formed between the teeth. The stator coils 7 of respective phases are inserted into the slots across a plurality of slots and attached thereto. Both ends of the stator 5 are held by a front bracket 18 and a rear bracket 19.

A pulley 1 is attached to one end of the shaft 2. A slip ring 14 is provided on the other end of the shaft 2. The slip ring 14 makes contact with a brush 15 to thereby supply power to the field coil 13. Further, a front fan 16 and a rear fan 17 are respectively provided on end faces of the front side claw-like magnetic pole 11 and the rear side claw-like magnetic pole 12 of the rotor 4 on the outer peripheral side. Each of the front fan 16 and the rear fan 17 is a cooling fan having a plurality of blades. Accordingly, cooling wind CW is circulated so that air is introduced from the outside and air that has cooled the inside is discharged to the outside as indicated by broken lines by centrifugal force generated by the rotation of the front fan 16 and rear fan 17. The stator coils 7 are cooled with the cooling wind.

In this example, the stator coils 7 include two sets of three-phase coils. Lead wires of the respective coils are connected to rectifier circuits 20. Each of the rectifier circuit 20 includes a rectifier element such as a diode, and forms a full-wave rectifier circuit. For example, when the rectifier element is a diode, a cathode terminal is connected to a diode connection terminal 21. Further, an anode terminal is electrically connected to a vehicle AC power generator main body. A rear cover 22 serves as a protection cover for the rectifier circuits 20.

Next, a power generation operation will be described.

First, along with the start of an engine, rotation is transmitted to the pulley 1 from a crankshaft through a belt, so that the rotor 4 is rotated through the shaft 2. At this point, by supplying a direct current to the field coil 13 provided in the rotor 4 from the brush 15 through the slip ring 14, a magnetic flux which circulates around inner and outer peripheries of the field coil 13 is generated. Therefore, the N and S poles are alternately formed in the peripheral direction on the front side claw-like magnetic pole 11 and the rear side claw-like magnetic pole 12 of the rotor 4. The magnetic flux generated by the field coil 13 passes from the N pole of the front side claw-like magnetic pole 11 through the stator core 6, then circulates around the stator coils 7, and reaches the S pole of the rear side claw-like magnetic pole 12 of the rotor 4. As a result, a magnetic circuit which circulates around the rotor 4 and the stator 5 is formed. Since the magnetic flux generated in the rotor interlinks with the stator coils 7 in this manner, AC induced voltages are generated in U1-phase, U2-phase, V1-phase, V2-phase, W1-phase, and W2-phase stator coils 7, so that AC induced voltages of six phases are generated as a whole.

The AC voltages generated in this manner are full-wave rectified by the rectifier circuits 20 each including the rectifier element such as a diode, and thereby converted into a DC voltage. The rectified DC voltage is achieved by controlling a current supplied to the field coil 13 by an IC regulator (not illustrated) so as to be a constant voltage.

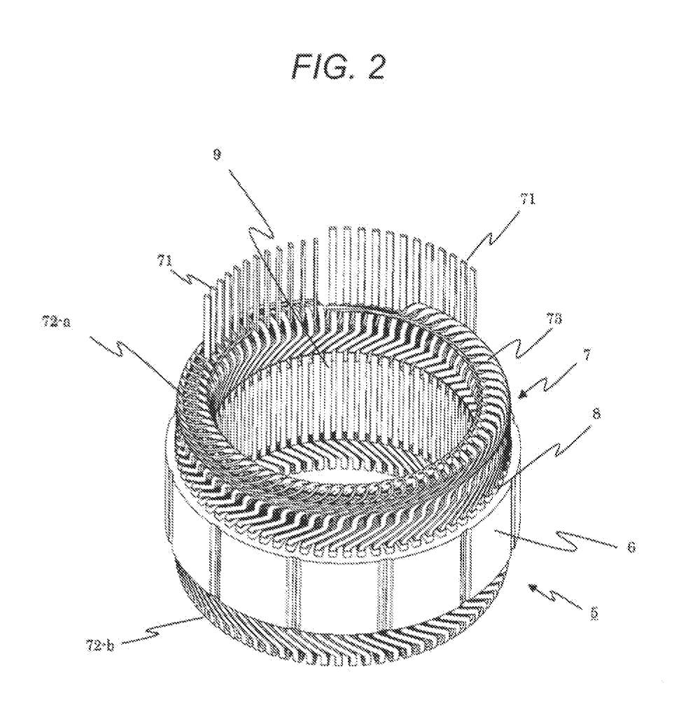

Next, the configuration of the stator used in the rotating electrical machine according to the present embodiment will be described with reference to FIGS. 2 to 11.

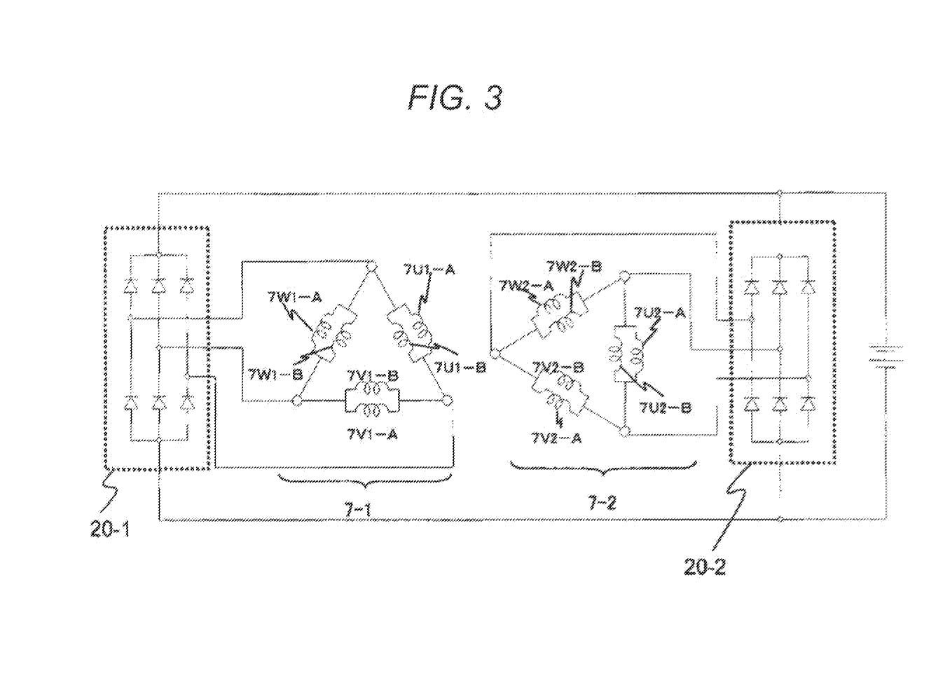

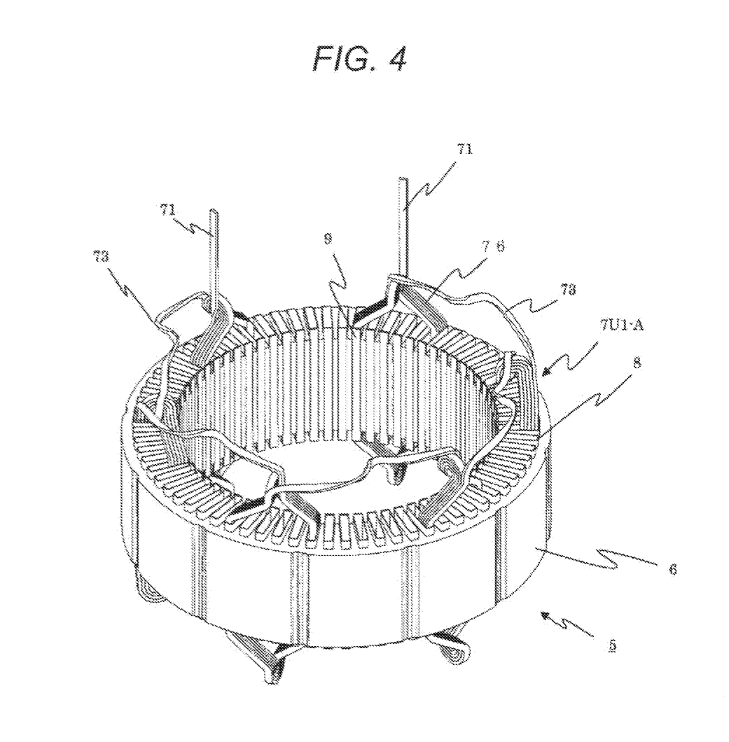

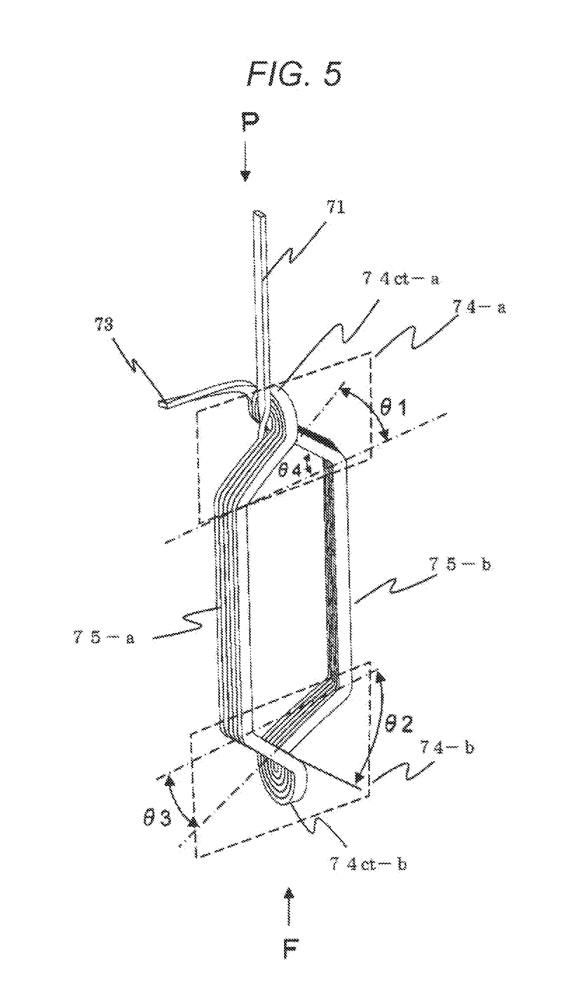

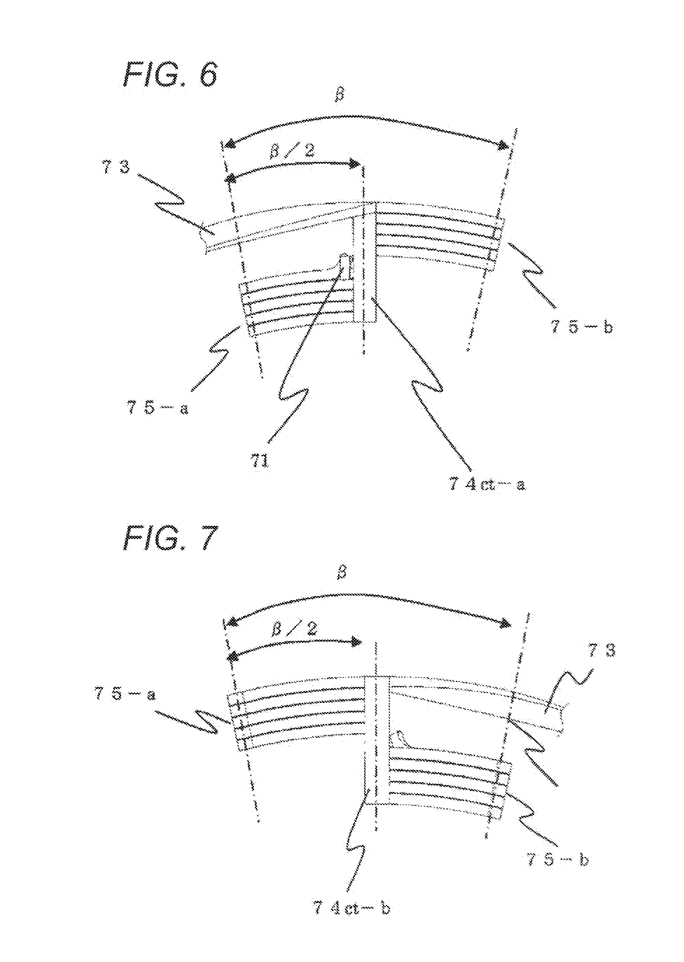

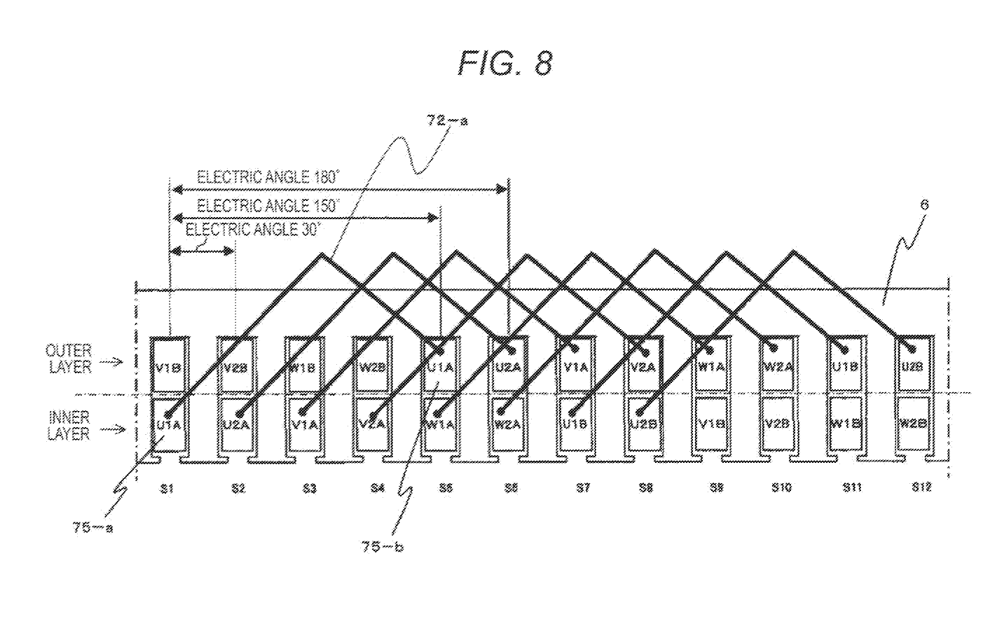

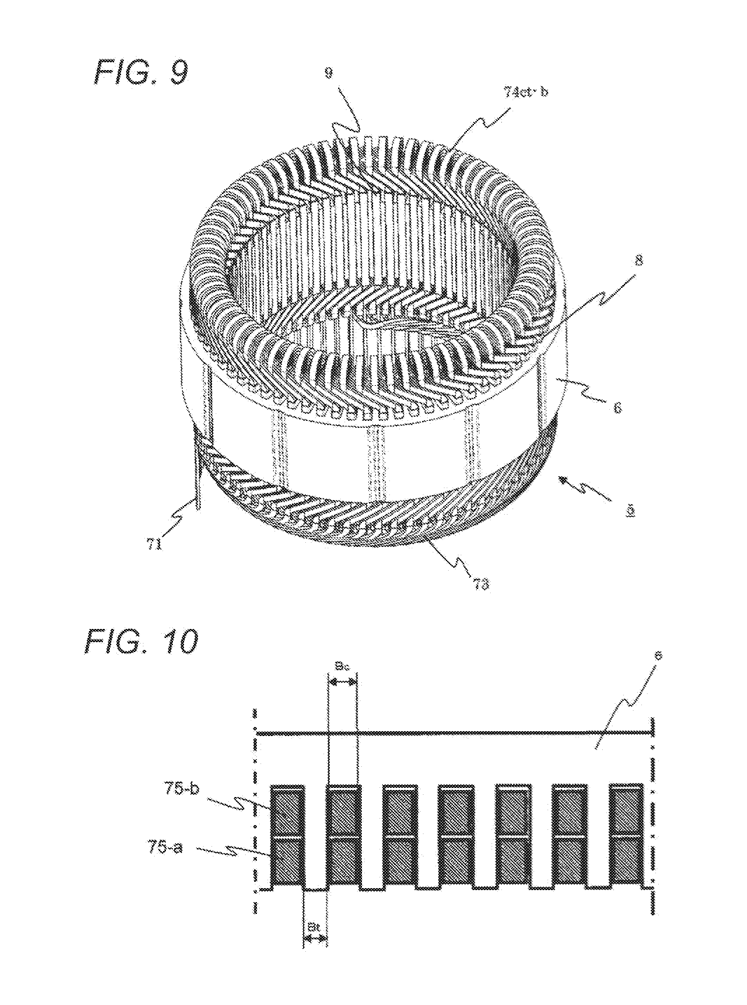

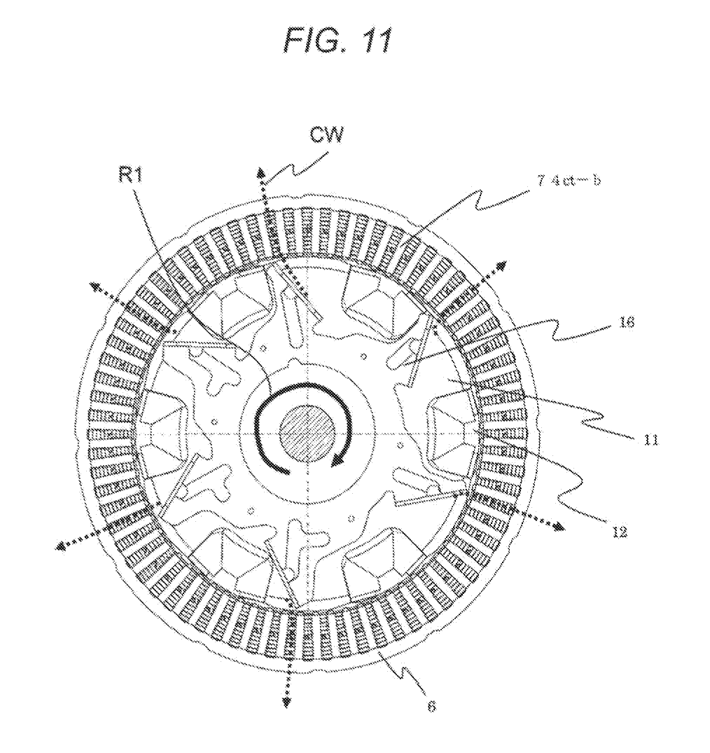

FIG. 2 is a perspective view of the stator used in the rotating electrical machine according to the first embodiment of the present invention when viewed from the rear side. FIG. 3 is a circuit diagram of the stator used in the rotating electrical machine according to the first embodiment of the present invention. FIG. 4 is a perspective view of a stator coil as a U1-phase A coil of the stator used in the rotating electrical machine according to the first embodiment of the present invention. FIG. 5 is a perspective view of a toroidal coil used in the rotating electrical machine according to the first embodiment of the present invention. FIG. 6 is a diagram viewed from P of FIG. 5. FIG. 7 is a diagram viewed from F of FIG. 5. FIG. 8 is a coil arrangement diagram in the stator core used in the rotating electrical machine according to the first embodiment of the present invention. FIG. 9 is a perspective view of the stator used in the rotating electrical machine according to the first embodiment of the present invention when viewed from the front side. FIG. 10 is a detailed view of a slot portion of the stator core used in the rotating electrical machine according to the first embodiment of the present invention. FIG. 11 is a cross-sectional view of the rotating electrical machine according to the first embodiment of the present invention.

As illustrated in FIG. 2, the stator 5 attaches thereto the stator coils 7 of the respective phases through the annular stator core 6 which has a plurality of slots formed in the peripheral direction on the inner peripheral surface thereof and U-shaped insulation sheets 8 which are attached to the inner peripheral surfaces of the respective slots, and includes slot wedges 9 which are formed on the innermost peripheries of the slots so as to hold the stator coil 7 inside the slots. In this example, the number of slots is 72.

Portions protruding from the slots of the stator core 6 in the axial direction are coil ends 72-a on the same side as the lead wires and coil ends 72-b on the opposite side of the lead wires each extending over two slots. As illustrated in the figure, twenty-four lead wires 71 are extracted. Since the number of lead wires 71 is 24, the number of coils is 12. As will be described with reference to FIG. 3, the twelve coils includes six A coils and six B coils.

Gaps of 1 mm or larger are formed between the respective wound coils of the stator coils. Since, when the rotating electrical machine is an electric motor, a voltage to be applied is high such as 300 V and 600 V, predetermined gaps (1 mm or larger) are formed in order to ensure insulation between the phases.

On the other hand, when the rotating electrical machine is a power generator, an output voltage thereof is 14 V and therefore low, the pressure resistance between the wires is not so required. Therefore, an insulation material (insulating varnish) is disposed in each of the gaps between the wound coils of the stator coils.

As illustrated in a connection diagram of FIG. 3, in the configuration of the present embodiment, each of the stator coils has the configuration of delta connection which is connected in a triangular shape. Further, two kinds of coils, that is, a first coil 7-1 and a second coil 7-2 are connected in parallel to each other. The first coil 7-1 is connected to a rectifier 20-1, and the second coil 7-2 is connected to a rectifier 20-2.

The delta-connected first coil 7-1 includes six coils (two U-phase coils 7U1-A and 7U1-B connected in parallel to each other, two V-phase coils 7V1-A and 7V1-B connected in parallel to each other, and two W-phase coils 7W1-A and 7W1-B connected in parallel to each other). The second coil 7-2 also includes six coils which are delta-connected.

Although the above coils are delta-connected, the rotating electrical machine can be achieved also when the coils are configured by series connection and star connection (Y connection).

As illustrated in FIG. 4, the U1-phase stator coil is configured in a form in which a plurality of coils each formed by being annularly wound are connected to each other by connectors 73. In this example, the number of slots per pole per phase is “two”. In the case of coils of 12 poles and 6 phases, the number of toroidal coils 76 is 12. The coils are connected to each other through the connectors 73 so as to be continuously formed. The number of turns of each of the toroidal coils 76 is, for example, five (5T). In the illustrated example, a U1-phase first stator coil 7U1-A is illustrated. The first stator coil 7U1-A includes six toroidal coils 76, five connectors 73 which connect the toroidal coils 76 to each other, and two lead wires 71 for connecting toroidal coils 76 located on both ends to the outside.

As illustrated in FIG. 3, the U1-phase stator coil 7U1 includes the 7U1-A coil and the 7U1-B coil. In FIG. 4, the 7U1-A coil is a stator coil having a configuration in which connectors 73-a are arranged on the same side as the lead wires 71, and the 7U1-B coil is also a stator coil having a configuration in which connectors 73-b are arranged on the same side as the lead wires 71, so that the connectors are arranged to be concentrated on the same side as the lead wires.

FIG. 5 illustrates the form of one toroidal coil 76. The toroidal coil 76 has a generally hexagonal shape, and includes a lead wire 71, coil end portions 74-a, 74-b each of which projects in the axial direction of the stator core, coil slot portions 75-a, 75-b which are attached to slots of the stator core, and a connector 73 which connects toroidal coils to each other. The coil end portions 74-a, 74-b respectively have coil turn portions 74ct-a, 74ct-b each of which is folded in a U shape on the vertex of a triangle in the corresponding coil end portion.

Winding order of the toroidal coil 76 is as follows. As illustrated in FIG. 5, the toroidal coil 76 enters the coil end portion 74-a from the lead wire 71, then enters the toroidal coil slot portion 75-a which is to be inserted into a slot of the stator core from the coil end portion 74-a at an angle of θ1, and then extends to the coil end portion 74-b on the opposite side of the lead wire while keeping an angle of θ2.

In the coil end turn portion 74ct-b which is the vertex of the coil end portion as well as a returning point, the toroidal coil 76 is bent in the axial direction near the vertex of the coil end portion so as to turn from an inner layer of the slot toward an outer layer in a U shape after facing the axial direction.

In the coil turn portion 74ct-b, U shapes are aligned so to be laminated in the axial direction by the number of turns.

After turning in a U shape in the coil turn portion 74ct-b, the toroidal coil 76 is bent at an angle of θ3 in the coil end 72-b on the opposite side of the lead wire, and then enters a coil slot portion 75-b which is to be inserted into a slot portion on the outer layer side of the stator core from the coil end 72-ba on the opposite side of the lead wire.

The coil that has entered the coil slot portion 75-b is discharged toward the lead wire, and passes through the coil end portion 74-a on the same side as the lead wire 71 at an angle of θ4.

In the coil end turn portion 74ct-b which is the vertex of the coil end portion, the coil is once bent in the axial direction near the vertex of the coil end portion so as to U-turn from the outer layer of the slot toward the outer layer in a U shape after facing the axial direction.

In the coil turn portion 74ct-a, U shapes are aligned so to be laminated in the axial direction by the number of turns. After turning in a U shape in the coil turn portion 74ct-a, the toroidal coil 76 enters the toroidal coil slot portion 75-a which is to be inserted into a slot protion of the stator core from the coil end portion 74-a at the angle of θ1. In this manner, the toroidal coil 76 makes one round in a hexagonal shape to form one turn (1T).

This is repeatedly performed by the number of times of a predetermined number of turns to thereby wind the coil by a predetermined number of turns necessary for the characteristics of the rotating electrical machine.

In the coil turn portions 74ct, the coil has a form in which winding turns thereof are overlapped with each other in the axial direction.

Each of the angles θ01 to θ4 of the coil end portions is desirably 30° to 50°.

FIG. 6 is a diagram illustrating the toroidal coil of FIG. 5 when viewed from P as the axial direction. The position of the coil turn portion 74ct-a is located at an angle β/2 which is a half of an angle β between the slot coil portion 75-a and the slot coil portion 75-b.

FIG. 7 is a diagram illustrating the toroidal coil of FIG. 5 when viewed from F as the axial direction. The position of the coil turn portion 74ct-b is located at the angle β/2 which is a half of the angle β between the slot coil portion 75-a and the slot coil portion 75-b.

FIG. 8 is an arrangement diagram of the stator coil in the slots, the stator coil being attached to the stator core.

The arrangement pitch of the toroidal coils 76 is an electric angle of 360° which is equal to a pole pitch. The coil pitch of each of the toroidal coils is a short pitch in which the toroidal coil is wound at an electric angle of 150° which is smaller than an electric angle of 180° which is smaller than the pole pitch.

Winding in which a toroidal coil used in the stator coil is inserted into slots across a plurality of teeth at a coil pitch narrower than a full pitch which is equal to the pole pitch (short pitch=an electric angle of less than 180°) is referred to as short pitch winding. On the other hand, winding in which a toroidal coil used in the stator coil is inserted into slots across a plurality of teeth at the full pitch which is equal to the pole pitch (full pitch=an electric angle of 180°) is referred to as full pitch winding.

Further, stator coils of V1 to W2 phases have the same configuration as above.

The toroidal coil 76 illustrated in FIG. 5 is attached to the stator core. The arrangement of the stator coils 7 is divided into two in the radial direction of the slots as illustrated in FIG. 8 to form a two-layer coil arrangement in which the inner layer is defined on the side of slot openings and the outer layer is defined on the side of the outer periphery of the stator core 6.

The stator coils 7 of the respective phases are divided into two kinds of coils, namely, into A coils and B coils. In FIG. 8, for example, two U1-phase stator coils 7 are defined as U1A of A coil and U1B of B coil. The toroidal coil U1A is arranged on the inner layer of the first slot S1 and the outer layer of the fifth slot S5, and ends thereof are connected to each other in the coil end portion to form the toroidal coil 76.

That is, the coil pitch of the U1-phase toroidal coil is an electric angle of 150° which is smaller than an electric angle of 180° which is smaller than the pole pitch.

On the other hand, the toroidal coil U1B is arranged on the inner layer of the seventh slot S7 and the outer layer of the eleventh slot S11, and ends thereof are connected to each other in the coil end portion to form the toroidal coil 76.

That is, the coil pitch of the U2-phase toroidal coil is an electric angle of 150° which is smaller than an electric angle of 180° which is smaller than the pole pitch. The toroidal coils of V1 to W2 phases have the same configuration as above.

The toroidal coils attached as illustrated in the slot arrangement diagram of FIG. 8 are connected to each other by the connectors 73 as illustrated in FIG. 4. The stator coils 7 of the respective phases are connected to each other as illustrated in the connection diagram illustrated in FIG. 3, and connected to the rectifiers to thereby achieve the vehicle AC power generator of the first embodiment that is provided with the stator having two sets of three-phase wire connections.

FIG. 9 illustrates the stator 5 which includes the toroidal coil 76 of FIG. 5 when viewed from the front side.

As illustrated in FIG. 9, the coil turn portions 74ct-b each of which is the vertex of the coil end are radially aligned so that the U shapes thereof are located in the radial direction of the stator, and predetermined gaps are provided between the coil turn portions 74ct-b.

By aligning the U shapes of the coil turn portions 74ct-b in the radial direction in the longitudinal direction of the slots, as illustrated in FIG. 10, even when the ratio of the slot teeth width Bt to the coil width Bc (Bt/Bc) is less than 1, gaps in the coil turn portions can be maintained constant. Therefore, the stator can be configured without causing interference in the coil end portions.

Further, constant gaps can be maintained also in the case of a high-voltage motor or the like. Therefore, the stator can be configured with no interphase insulation sheet, and a high quality stator can be provided at a low cost.

FIG. 11 is a cross-sectional view of the vehicle AC power generator of FIG. 1. The rotor 4 is arranged on the inner peripheral side of the stator 5. The front fan 16 is arranged on the front side claw-like magnetic pole of the rotor 4. The rotor rotates in the direction indicated by arrow R1, and cooling wind is thereby radially generated from the center toward the outer periphery to cool the stator coils 7.

In the present embodiment, the coil turn portions 74ct-b of the coil end portions 74-b are radially arranged as illustrated in FIG. 9, and certain gaps are formed between the coil turn portions 74ct-b.

As described above, according to the present embodiment, since the coil end portions 74-b are formed so as to allow cooling wind to easily pass in the radial direction, the gaps have low flow path resistance and the coolability for the stator coils 7 can therefore be efficiently improved. As a result, it is possible to achieve a high-quality, high-output, and high-efficiency stator provided with stator coils with excellent coolability.

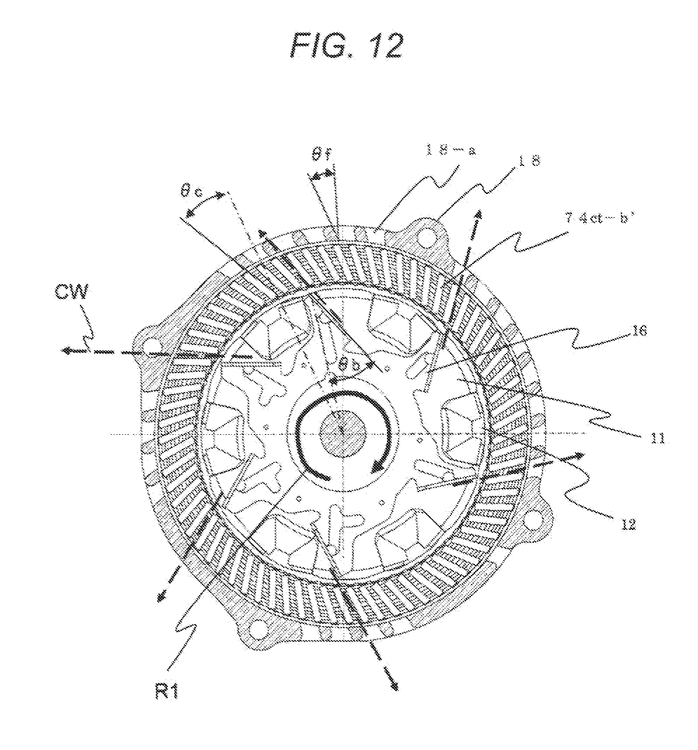

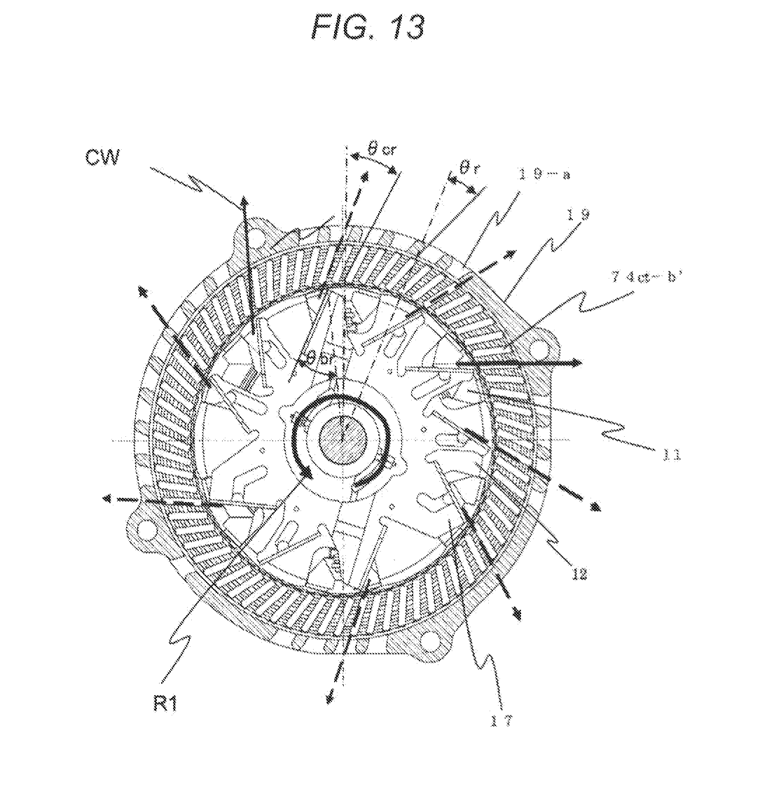

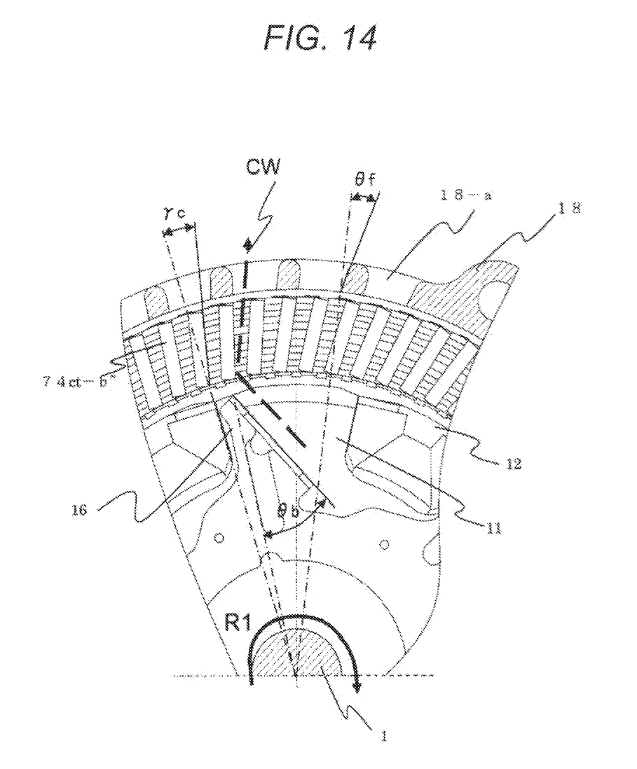

Next, the configuration of a rotating electrical machine according to a second embodiment of the present invention will be described with reference to FIGS. 12 and 13. The entire configuration of the rotating electrical machine according to the present embodiment is the same as the rotating electrical machine illustrated in FIG. 1.

FIG. 12 is a cross-sectional view of the rotating electrical machine according to the second embodiment of the present invention near a front fan. FIG. 13 is a cross-sectional view of the rotating electrical machine according to the second embodiment of the present invention near a rear fan.

The first embodiment described above employs the structure in which each of the coil turn portions 74ct-b is inclined vertically with respect to the center in order to avoid interference in the coil end portions and improve the coolability.

On the other hand, an object of the present embodiment is to achieve a structure that is capable of improving the effect of cooling wind in a vehicle AC power generator of the present embodiment to the maximum, specifically, to improve the coolability by reducing the flow path resistance on the cooling wind discharge side to thereby increase the wind volume.

FIG. 12 is a diagram illustrating the positional relationship between a front fan 16 and stator coils 7. As illustrated in FIG. 12, when an exit angle θb of a blade of the front fan 16 is equal to an arrangement angle θc of a coil turn portion 74ct-b, the exit angle of the cooling fan and the coil turn portion 74ct-b are linearly located. Accordingly, it is possible to discharge cooling wind to the outside with low flow path resistance, and increase the wind volume.

When the angle θc of the coil turn portion becomes large, an entrance for cooling wind that enters the coil end portion becomes narrow, which causes flow path resistance. Therefore, the angle θc is desirably 40° or less.

Further, as illustrated in FIG. 12, by also making an angle θf an exhaust window 18-a of a front bracket equal to the exit angle θb of the blade of the cooling fan and the arrangement angle θc of the coil turn portion 74ct-b, cooling wind linearly passes from the exit angle of the blade of the fan, through the coil turn portion and a cover, and is discharged to the outside. Therefore, it is possible to largely reduce the flow path resistance to increase the wind volume, and thereby improve the coolability.

Although the coil end portion 74-b located on the same side as the front fan 16 has been described, a coil end portion 74-a located on the same side as a rear fan 17 has the same configuration. FIG. 13 is a diagram illustrating the positional relationship between the rear fan 17 and the stator coils 7. As illustrated in FIG. 13, when an exit angle θbr of a blade of the rear fan 17 is equal to an arrangement angle θcr of a coil turn portion 74ct-a, the exit angle of the cooling fan and the coil turn portion 74ct-b are linearly located. Accordingly, it is possible to discharge cooling wind to the outside with low flow path resistance, and increase the wind volume.

Further, by also making an angle θr of an exhaust window 19-a of a rear bracket 19 equal to the exit angle θbr of the blade of the rear fan 17 and the arrangement angle θcr of the coil turn portion 74ct-a, cooling wind linearly passes from the exit angle of the blade of the fan, through the coil turn portion and a cover, and is discharged to the outside. Therefore, it is possible to largely reduce the flow path resistance to increase the wind volume, and thereby improve the coolability.

When the angle θc of the coil turn portion becomes large, an entrance for cooling wind that enters the coil end portion becomes narrow, which causes flow path resistance. Therefore, the angle θc is desirably 40° or less.

Since the arrangement angles of the coil turn portions are set according to the front fan 16 and the rear fan 17, it is possible to effectively cool the stator coils.

Therefore, the arrangement angle of the coil turn portions located on the same side as lead wires and the arrangement angle of the coil turn portions located on the opposite side of the lead wires (front fan side) may be changed, and it is possible to effectively increase the wind volume to the maximum.

According to the present embodiment described above, the wind volume increases by reducing the flow path resistance on the exit side of the fans, and the coolability for the coils and the coolability for various parts are thereby improved. Therefore, it is possible to achieve a rotating electrical machine that includes a high-quality, high-output, and high-efficiency stator provided with stator coils with excellent coolability.

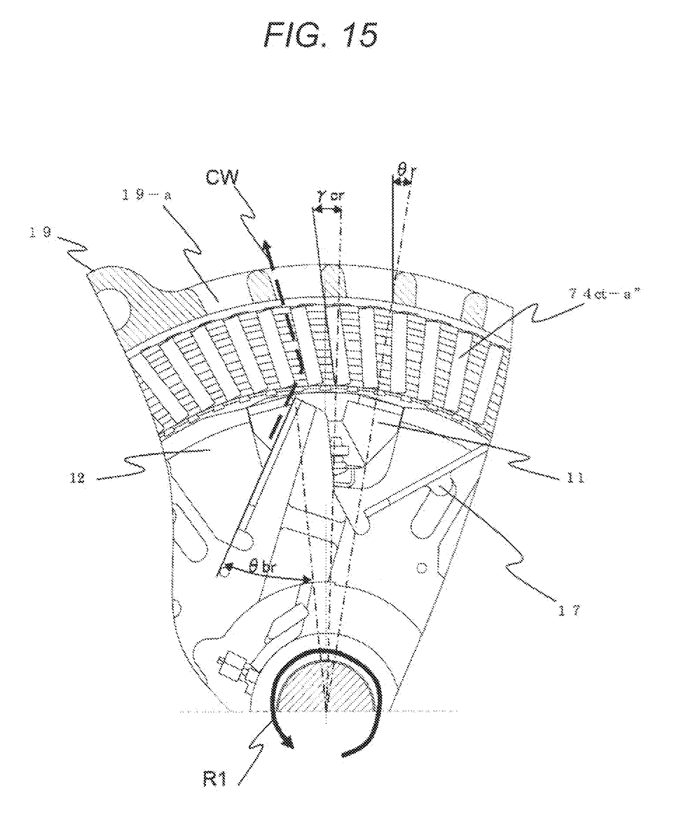

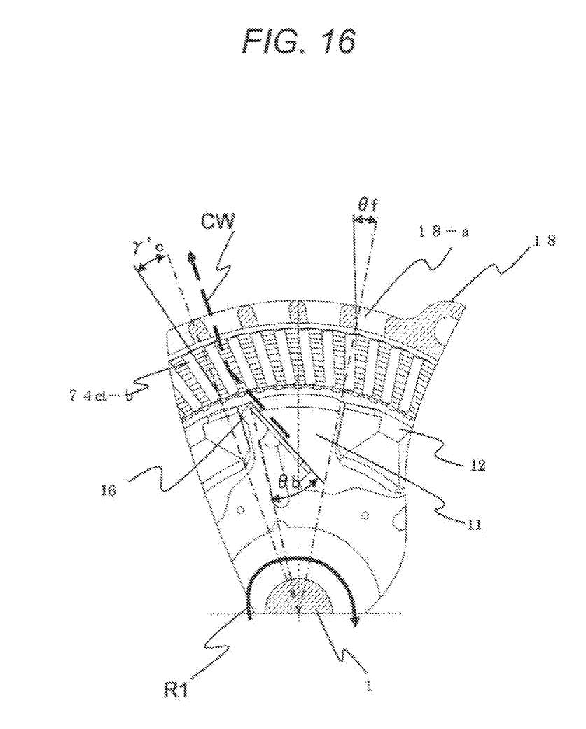

Next, the configuration of a rotating electrical machine according to a third embodiment of the present invention will be described with reference to FIGS. 14 and 15. The entire configuration of the rotating electrical machine according to the present embodiment is the same as the rotating electrical machine illustrated in FIG. 1.

FIG. 14 is a cross-sectional view of the rotating electrical machine according to the third embodiment of the present invention near a front fan. FIG. 15 is a cross-sectional view of the rotating electrical machine according to the third embodiment of the present invention near a rear fan.

In the first and second embodiments described above, the wind volume increases by reducing the flow path resistance on the exist side of the fans, thereby also improving the coolability for the coils and the coolability for various parts.

On the other hand, it is an object of the present embodiment to improve the coolability for stator coils 7 by applying cooling wind to the side faces of coil turn portions.

FIG. 14 is a cross-sectional view illustrating the positional relationship between a front fan 16 and stator coils 7. As illustrated in FIG. 14, an exit angle θb of a blade of the front fan 16 is angled in a direction opposite to the rotation direction. On the other hand, an arrangement angle γc of a coil turn portion 74ct-b is angled in a direction opposite to the angle of the blade. Accordingly, cooling wind is discharged to the outside of a front bracket 18 while being applied to the side faces of the coil turn portions 74ct-b. As a result, the coolability for the stator coils is improved.

When the arrangement angle γc of the coil turn portion 74ct-b is too large, the flow path resistance increases and the width of an entrance to a flow path between the coil turn portions 74ct-b is narrowed, which results in a decrease in the wind volume. Therefore, by setting the sum of the exit angle θb of the blade of the front fan 16 and the arrangement angle γc of the coil turn portion 74ct-b within the range of 60° or less, it is possible to improve the coolability for the stator coils 7 while reducing the flow path resistance.

Further, as illustrated in FIG. 14, by making an angle θf an exhaust window 18-a of the front bracket equal to the arrangement angle γc of the coil turn portion 74ct-b, it is possible to reduce the flow path resistance to increase the wind volume, and thereby improve the coolability.

The arrangement angle γc of the coil turn portion 74ct-b is desirably set to 45° or less. When the arrangement angle γc is 45° or more, and the ratio of the slot teeth width Bt to the coil width Bc (Bt/Bc) is 1 or less in a stator core, the interference between the coil turn portions 74ct-b may disadvantageously occur. Therefore, a problem such that the space factor cannot be improved occurs.

Although the coil end portion 74-b located on the same side as the front fan 16 has been described, a coil end portion 74-a located on the same side as a rear fan 17 has the same configuration.

FIG. 15 is a cross-sectional view illustrating the positional relationship between the rear fan 17 and the stator coils 7. As illustrated in FIG. 15, an exit angle θbr of a blade of the rear fan 17 is angled in a direction opposite to the rotation direction. On the other hand, an arrangement angle γcr of a coil turn portion 74ct-a is angled in a direction opposite to the angle of the blade. Accordingly, cooling wind is discharged to the outside of a rear bracket 19 while being applied to the side faces of the coil turn portions 74ct-a. As a result, the coolability for the stator coils is improved.

When the arrangement angle γcr of the coil turn portion 74ct-a is too large, the flow path resistance increases and the width of an entrance to a flow path between the coil turn portions 74ct-a is narrowed, which results in a decrease in the wind volume. Therefore, by setting the sum of the exit angle θbr of the blade of the rear fan 17 and the arrangement angle γcr of the coil turn portion 74ct-a within the range of 60° or less, it is possible to improve the coolability for the stator coils 7 while reducing the flow path resistance.

Further, as illustrated in FIG. 15, by making an angle θfr of an exhaust window 19-a of the rear bracket equal to the arrangement angle γcr of the coil turn portion 74ct-a, it is possible to reduce the flow path resistance to increase the wind volume, and thereby improve the coolability.

The arrangement angle γcr of the coil turn portion 74ct-a is desirably set to 45° or less. When the arrangement angle γcr is set to 45° or more, and the ratio of the slot teeth width Bt to the coil width Bc (Bt/Bc) is 1 or less in a stator core, the interference between the coil turn portions 74ct-a may disadvantageously occur. Therefore, a problem such that the space factor cannot be improved occurs.

Since the arrangement angles of the coil turn portions are set according to the front fan 16 and the rear fan 17, it is possible to effectively cool the stator coils.

Therefore, the arrangement angle of the coil turn portions located on the same side as lead wires and the arrangement angle of the coil turn portions located on the opposite side of the lead wires (front fan side) may be changed, and it is possible to improve the coolability for the stator coils by effectively increasing the wind volume to the maximum and directly applying the cooling wind to the coil turn portions.

According to the present embodiment described above, the coolability is improved by applying cooling wind to the coil turn portions by changing the angle of the exit side of the fans and the angle of the coil turn portions. As a result, it is possible to achieve a rotating electrical machine that includes a high-quality, high-output, and high-efficiency stator that is excellent in the coolability for stator coils.

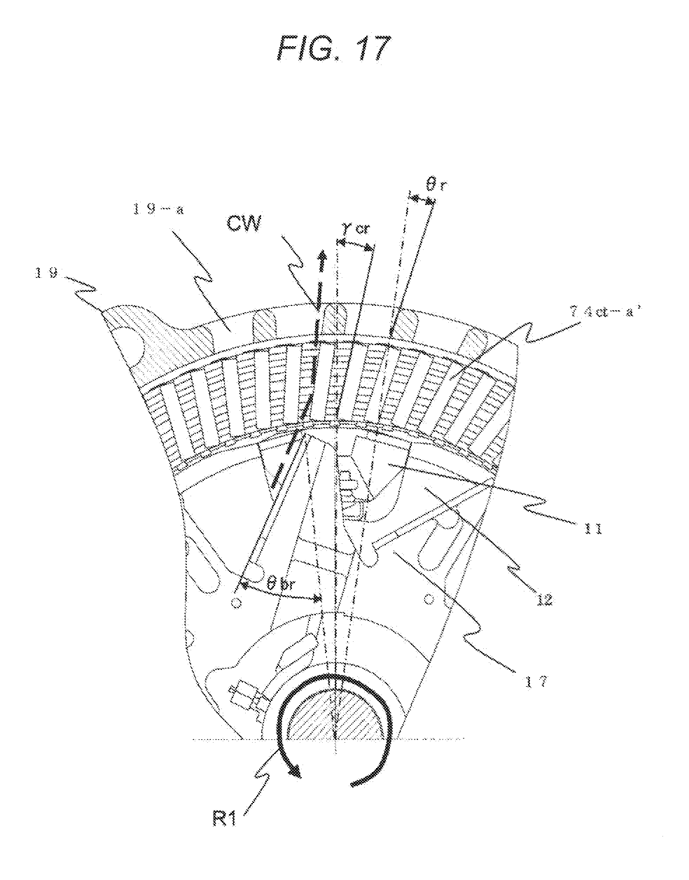

Next, the configuration of a rotating electrical machine according to a fourth embodiment of the present invention will be described with reference to FIGS. 16 and 17. The entire configuration of the rotating electrical machine according to the present embodiment is the same as the rotating electrical machine illustrated in FIG. 1.

FIG. 16 is a cross-sectional view of the rotating electrical machine according to the fourth embodiment of the present invention near a front fan. FIG. 17 is a cross-sectional view of the rotating electrical machine according to the fourth embodiment of the present invention near a rear fan.

In the third embodiment described above, cooling wind is applied to the coil turn portions by changing the angle of the exit side of the fans and the angle of the coil turn portions to thereby improve the coolability for the stator coils. However, in the third embodiment, the flow path resistance is large, and the wind volume therefore decreases compared to the second embodiment.

Therefore, it is an object of the present embodiment to improve the coolability for stator coils 7 by applying cooling wind to the side faces of coil turn portions and also by suppressing a decrease in the wind volume.

FIG. 16 is a cross-sectional view illustrating the positional relationship between a front fan 16 and the stator coils 7. As illustrated in FIG. 16, an exit angle θb of a blade of a front fan 16 is angled in a direction opposite to the rotation direction. On the other hand, an arrangement angle γ′c of a coil turn portion 74ct-b is angled in the same direction as the angle of the blade. Accordingly, cooling wind is smoothly discharged to the outside of a front bracket 18 while being applied to the side faces of the coil turn portions 74ct-b. As a result, the coolability for the stator coils is improved.

When the arrangement angle γc of the coil turn portion 74ct-b is too large, cooling wind is discharged to the outside without being applied to the side face of the coil turn portion 74ct-b. Therefore, by setting the difference between the exit angle θb of the blade of the front fan 16 and the arrangement angle γ′c of the coil turn portion 74ct-b so as not to be 0°, it is possible to reliably apply the cooling wind to the side face of the coil turn portion 74ct-b, and thereby improve the coolability for the stator coils 7.

Further, as illustrated in FIG. 16, by making an angle θf an exhaust window 18-a of the front bracket equal to the arrangement angle γ′c of the coil turn portion 74ct-b, it is possible to reduce the flow path resistance to increase the wind volume, and thereby improve the coolability.

The arrangement angle γ′c of the coil turn portion 74ct-b is desirably set to 45° or less. When the arrangement angle γ′c is 45° or more, and the ratio of the slot teeth width Bt to the coil width Bc (Bt/Bc) is 1 or less in a stator core, the interference between the coil turn portions 74ct-b may disadvantageously occur. Therefore, a problem such that the space factor cannot be improved occurs.

Although the coil end portion 74-b located on the same side as the front fan 16 has been described, a coil end portion 74-a located on the same side as a rear fan 17 has the same configuration.

FIG. 17 is a cross-sectional view illustrating the positional relationship between the rear fan 17 and the stator coils 7. An exit angle θbr of a blade of the rear fan 17 is angled in a direction opposite to the rotation direction. On the other hand, an arrangement angle γ′cr of the coil turn portion 74ct-a is angled in the same direction as the angle of the blade. Accordingly, cooling wind is smoothly discharged to the outside of a rear bracket 19 while being applied to the side faces of the coil turn portions 74ct-a. As a result, the coolability for the stator coils is improved.

When the arrangement angle γ′cr of the coil turn portion 74ct-a is too large, the flow path resistance increases and the width of an entrance to a flow path between the coil turn portions 74ct-a is narrowed, which results in a decrease in the wind volume. Therefore, by setting the sum of the exit angle θbr of the blade of the rear fan 17 and the arrangement angle γcr of the coil turn portion 74ct-a within the range of 60° or less, it is possible to improve the coolability for the stator coils 7 while reducing the flow path resistance.

Further, as illustrated in FIG. 15, by making an angle θfr of an exhaust window 19-a of the rear bracket equal to the arrangement angle γ′cr of the coil turn portion 74ct-a, it is possible to reduce the flow path resistance to increase the wind volume, and thereby improve the coolability.

The arrangement angle γ′cr of the coil turn portion 74ct-a is desirably set to 45° or less. When the arrangement angle γ′cr is 45° or more, and the ratio of the slot teeth width Bt to the coil width Bc (Bt/Bc) is 1 or less in a stator core, the interference between the coil turn portions 74ct-a may disadvantageously occur. Therefore, a problem such that the space factor cannot be improved occurs.

Since the arrangement angles of the coil turn portions are set according to the front fan 16 and the rear fan 17, it is possible to effectively cool the stator coil.

Therefore, the arrangement angle of the coil turn portions located on the same side as lead wires and the arrangement angle of the coil turn portions located on the opposite side of the lead wires (front fan side) may be changed, and it is possible to improve the coolability for the stator coils by effectively increasing the wind volume to the maximum and directly applying the cooling wind to the coil turn portions.

According to the present embodiment described above, the coolability is improved by applying cooling wind to the coil turn portions by changing the angle of the exit side of the fans and the angle of the coil turn portions, and the wind volume is prevented from decreasing by setting the exit angle of the blades of the fans and the arrangement angle of the coil turn portions to be equal to each other. As a result, it is possible to achieve a rotating electrical machine that includes a high-quality, high-output, and high-efficiency stator that is excellent in the coolability for stator coils.

In the first to third embodiments described above, the stator coils 7 of different six phases are attached to the stator core 6, and stator coils of two phases having different electric angles are then connected in parallel to each other and connected to the rectifiers 20. However, the same effect can be obtained when the two stator coils are connected in series. In this case, an effect of reducing the number of lead wires can be obtained.

Further, although the above embodiments have the configuration of delta connection, the same effect can be obtained by star connection.

Further, in the first embodiment, the stator in which the coil pitch of the stator coils is 5/6 (electric angle of 150°) has been described. However, the configuration of a stator in which the coil pitch of a stator coil is 4/6 (electric angle of 120°) or 6/6 (electric angle of 180°) is also effective, and can achieve the same effect.

Further, although the stator having two sets of three-phase coils has been described, the same effect can be obtained in a stator having multiple-phase coils such as three-phase, five-phase, and seven-phase.

Further, in each of the above embodiments, the vehicle AC power generator has been described as an example of the rotating electrical machine. However, the present invention can also be applied to a motor which outputs rotation power, a motor generator which serves as a generator and a drive motor, and the like. In particular, as a motor, the stator of the above embodiments can be applied to a stator of a drive motor for a hybrid motor vehicle or electric four-wheel drive vehicle, a motor for driving a pump, and the like.

### REFERENCE SIGNS LIST

1 pulley
2 shaft
3 front bearing
4 rotor
5 stator
6 stator core
7 stator coil
71 lead wire
73 connector
74-a coil end on the same side as lead wire
74-b coil end on opposite side of lead wire
74ct-a coil turn portion on coil end vertex on the same side as lead wire
74ct-b coil turn portion on coil end vertex on opposite side of lead wire
75-a coil attached to inner layer of stator core slot
75-b coil attached to outer layer of stator core slot
76 toroidal coil
8 insulation sheet
9 slot wedge
10 rear bearing
11 front side claw-like magnetic pole
12 rear side claw-like magnetic pole
13 field coil
14 slip ring
15 brush
16 front fan
17 rear fan
18 front bracket
19 rear bracket
22 rear cover
20 rectifier circuit
21 diode connection terminal
23 vehicle AC power generator

1. A rotating electrical machine, comprising:
a stator; and
a rotor rotatably supported on an inner peripheral side of the stator with a gap therebetween,
the stator including:
an annular stator core having a plurality of slots open toward an inner peripheral surface; and
a plurality of sets of stator coils attached to the stator core through the slots and arranged over the entire circumference of the stator core, wherein
each of the stator coils includes a plurality of coils wound by a plurality of times across the slots and a connector which connects the wound coils to each other so as to be continuously formed,
coil turn portions which are folded on vertexes of coil ends arranged in the axial direction of the stator core are each formed in a U shape,
the coil turn portions on the vertexes of the coil ends are radially arranged so that side faces thereof face the center, and
a gap penetrating from an inner peripheral side to an outer peripheral side is provided between adjacent ones of the coil turn portions on the vertexes of the coil ends.

2. The rotating electrical machine according to claim 1, wherein turns of the coils wound by a plurality of times of each of the stator coils are aligned by a number of turns in the radial direction in a slot portion and aligned by a number of turns so as to be laminated in the axial direction in the coil turn portions on the vertexes of the coil ends.

3. The rotating electrical machine according to claim 2, wherein each of the coil turn portions of the coil ends is arranged at an intermediate portion between positions of a toroidal coil, the positions being inserted into slots of the stator core.

4. The rotating electrical machine according to claim 2, wherein an arrangement angle of each of the coil turn portions on the vertexes of the coil ends is equal to an angle of an exhaust window of a rear frame.

5. The rotating electrical machine according to claim 4, wherein an exit angle of a blade of a cooling fan is equal to the arrangement angle of each of the coil turn portions on the vertexes of the coil ends.

6. The rotating electrical machine according to claim 2, wherein the coil turn portions on the vertexes of the coil ends are arranged so that cooling wind generated by a blade of a cooling fan is applied to side faces of the coil turn portions on the vertexes of the coil ends.

7. The rotating electrical machine according to claim 1, wherein
each of the coils is a rectangular wire having a generally rectangular cross section,
each of the coils wound by a plurality of times of the stator coils has a hexagonal shape,
each of the slots of the stator core is divided into two in the radial direction, and one of coil portions to be inserted into a slot portion of each of the coils wound by a plurality of times of the stator coils is inserted into an outer peripheral side of a slot and the other coil portion is arranged in an inner peripheral side of a slot,
an arrangement pitch of the coils wound by a plurality of times of the stator coils is equal to a pole pitch in each phase,
a coil pitch of the coils wound by a plurality of times of the stator coils is shorter than the pole pitch, and
the coil pitch of the coils wound by a plurality of times of the stator coils is 4/6 to 5/6.
